(19) United States
(12) Patent Application Publication
(10) Pub. No.: US 2003/0213094 A1
(43) Pub. Date: Nov. 20, 2003

(54) Temporary drawer and cabinet door pull

(76) Inventor: William E. Wills, Beaverton, OR (US)

Correspondence Address: DELLETT AND WALTERS, 310 S.W. FOURTH AVENUE, SUITE 1101, PORTLAND, OR, 97204, US

(21) Appl. No.: 10/147,340

(22) Filed: May 15, 2002

(51) Int. Cl. E05B 1/00

(52) U.S. Cl. 16/110.1

(57) ABSTRACT

A temporary pull for cabinet doors or drawers comprises a clear plastic member with a grasping portion adapted to extend outwardly of the door or drawer, while a backing portion is adapted to adhesively secure to a back face of the door or drawer. The handle is capable of being repositioned and may be removed once permanent pulls are available.

### BACKGROUND OF THE INVENTION

This invention relates to construction and remodeling, and more specifically to drawer and cabinet door handles.

Cabinets and drawers, such as would be used in kitchens or bathrooms, for example, tend to be expensive, especially in the case of custom manufactured cabinets and drawers or specialty cabinets and drawers. The customers of the maker or supplier of drawers and cabinets typically want to choose their own style or design of pull handles and other hardware, to accommodate the decor of the particular site, or to meet the customer's particular taste or design concept. Typically the cabinet door handles and drawer pulls are custom ordered, and do not arrive until after the drawers or cabinets have been built and installed. But, the drawers and cabinets are built with doors that when closed, are flush with the frame of the cabinet or drawer, so it is difficult to open the doors or drawers unless handles are installed. Since each particular handle or pull that a given customer might want is likely to have a different mounting hole spacing or configuration, attaching any available handle or pull temporarily is not a desirable option, as mounting the handle to the doors or drawers would require drilling holes in the door or drawer face, which detracts from the value and appearance of the cabinets or drawers.

Since the door or drawer is flush with the surrounding frame, opening the cabinet or drawer can be difficult. The homeowner might try to open the drawer or door by inserting a finger nail into the small opening between the door or drawer and frame. This is undesirable, as it can result in broken finger nails or scratches or dings in the edges of the cabinet door or the drawer face.

To provide some means to open the cabinets and drawers, some builders or suppliers have attached a length of blue mask tape to fashion a crude handle. However, the tape is rather unsightly, and over a period of time, the tape would break and become tattered.

### SUMMARY OF THE INVENTION

In accordance with the invention, a temporary cabinet pull is provided that is adapted to be temporarily attached to the cabinet door, to allow easy opening of the doors. The temporary pull is easily removed from the cabinet door once a permanent handle or pull is available for mounting.

Accordingly, it is an object of the present invention to provide an improved temporary cabinet pull.

It is a further object of the present invention to provide an improved method of opening cabinets and drawers while waiting for permanent handle hardware to arrive.

It is yet another object of the present invention to provide an improved drawer pull or cabinet door handle that may be used in a temporary manner without damaging the appearance of the drawer face or cabinet door.

It is another object of the invention to provide an improved temporary handle for use with flush inset door and drawer styles.

The subject matter of the present invention is particularly pointed out and distinctly claimed in the concluding portion of this specification. However, both the organization and method of operation, together with further advantages and objects thereof, may best be understood by reference to the following description taken in connection with accompanying drawings wherein like reference characters refer to like elements.

### BRIEF DESCRIPTION OF THE DRAWINGS

FIG. 1 is a schematic front view of a cabinet with a temporary pull according to the invention installed on the door;

FIG. 2 is a sectional view of the pull as installed on the door, taken along line 2-2 of FIG. 1;

FIG. 3 is a perspective view of the temporary pull in accordance with the invention;

FIG. 4 is an end view of the temporary pull; and

FIGS. 5A, 5B and 5C are exemplary views of the temporary pull showing example dimensions of a preferred embodiment.

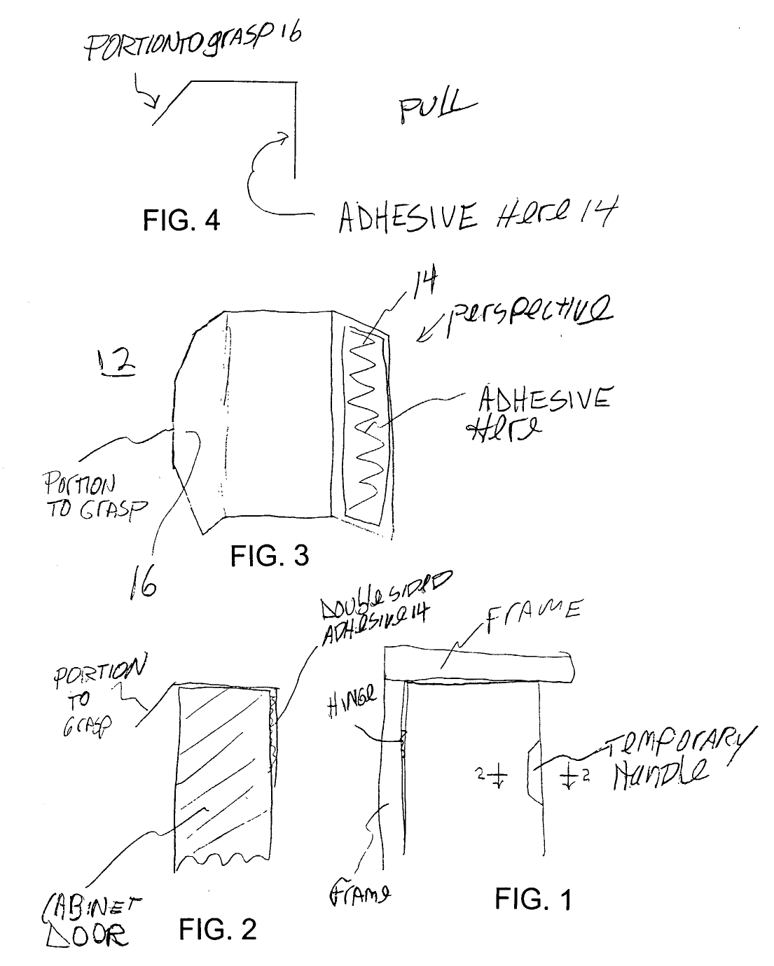

### DETAILED DESCRIPTION

According to a preferred embodiment of the present invention, a temporary pull is provided with an adhesive portion adapted to attach to a door or drawer, and a handle portion adapted for grasping to open the door or drawer. The adhesive is such that when the temporary pull is no longer needed, it may be removed without damage to the door or drawer.

A temporary cabinet door or drawer pull is shown in perspective and cross section views. The handle 12 includes a “peel and stick” type adhesive strip portion 14 on one face thereof, which allows the handle to be temporarily attached to the back face of a cabinet door or drawer face. The configuration of the temporary handle allows it to extend out from behind the door, and to stick out somewhat so that it may be grasped at portion 16, to enable the door to be pulled open.

Once the permanent handles are available for installation, the temporary handle is simply peeled off, leaving no visible markings or mounting holes.

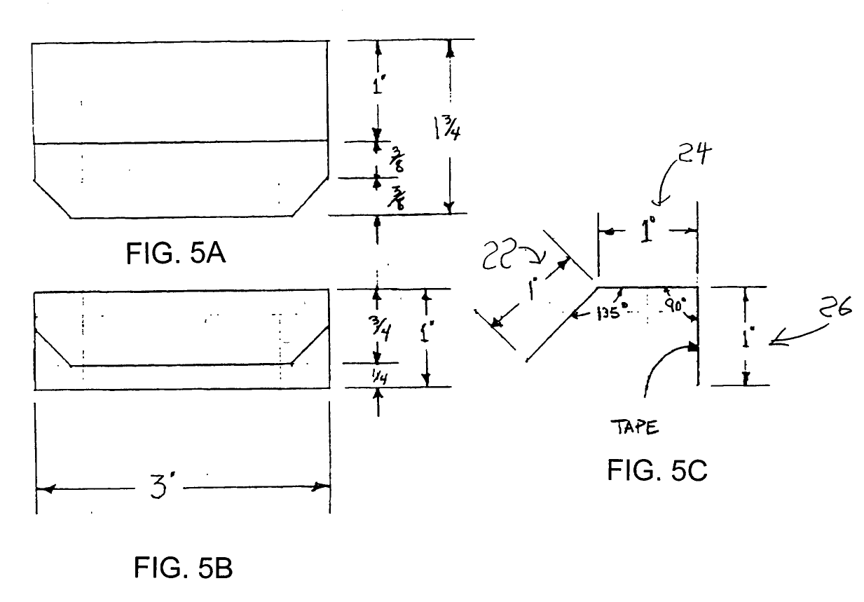

FIGS. 5A, 5B and 5C illustrate particular dimensions of a particular preferred embodiment, wherein the pull is 3 inches wide (reference 20), has a grasping handle length of one inch (reference 22), a face depth of one inch (reference 24) and a backing depth of one inch (reference 26). The angle between the grasping handle portion and the portion at 24 is suitably 135°, while the angle between the portion 24 and the backing portion is typically 90°. The left and right edges of the grasping handle a suitably beveled or curved, to present a smooth finish.

A suitable material of which the temporary pull may be constructed is a 0.012 inch thick polycarbonate, which can be clear for example. Also, the pull can be provided in any desired color to suit the tastes of the customer. The adhesive used is preferably a 3M brand tape item 9425PC, which is a double sided adhesive tape. The side of the tape not attached to the surface of the pull will suitably have a removable cover thereon to protect the adhesive until it is time to install the handle, whereupon the cover is peeled away to expose the adhesive for pressing against the cabinet door.

While the examples of use herein illustrate a cabinet door, a drawer pull is also a suitable use for the device, and in the view of FIG. 2, for example, the portion denoted cabinet door, may also be a drawer face.

Another use for the device is to assist in fitting glass or mirrors into frames. By applying the device to the glass or mirror, it provides a handle which allows easy lifting and repositioning of the glass or mirror relative to the frame.

Thus, in accordance with the invention, and temporary handles is provided that is durable enough to be used until permanent handles arrive. The handle is adapted for use on drawers and doors of varying sizes. In a preferred embodiment, it is clear and therefore is not offensive to the viewer's eyes. The handle can be repositioned as desired, is reusable, is inexpensive and is easy to install. The pulls may be relatively inexpensively manufactured, and therefore may be given free to end users when permanent pulls are back ordered or are otherwise not available.

While a preferred embodiment of the present invention has been shown and described, it will be apparent to those skilled in the art that many changes and modifications may be made without departing from the invention in its broader aspects. The appended claims are therefore intended to cover all such changes and modifications as fall within the true spirit and scope of the invention.

What is claimed is:

1. A temporary pull comprising:
a handle member adapted for placement against a door or drawer; and
an adhesive for temporarily securing the handle member to the door or drawer.

2. A temporary pull according to claim 1, wherein said handle member comprises a grasping portion adapted to extend outwardly of the door or draw when the pull is secured to the door or drawer.

3. A temporary pull according to claim 1, wherein said handle member comprises:
a grasping portion adapted for holding by a user;
a backing portion for engagement with a portion of the door or drawer and adapted for receiving the adhesive therebetween.

4. A temporary pull according to claim 3, wherein said grasping portion is at an angle to said facing portion.

5. A temporary pull according to claim 3, further comprising an intermediate face portion between said grasping portion and said backing portion.

6. A temporary pull according to claim 5, wherein said face portion is at an angle of approximately 90° to said backing portion.

7. A temporary pull according to claim 6, wherein said grasping portion is at an angle of approximately 135° to said facing portion.

8. A temporary pull according to claim 5, wherein said grasping portion is at an angle of approximately 135° to said facing portion.

9. A temporary pull according to claim 1, wherein said handle member comprises a polycarbonate.

10. A temporary pull according to claim 1, wherein said handle member has a thickness of approximately 0.012 inch.

11. A method of providing a pull, comprising:
providing a handle member adapted for placement against a door or drawer; and
providing an adhesive for temporarily securing the handle member to the door or drawer.

12. The method according to claim 11, wherein said step of providing a handle member comprises providing a grasping portion adapted to extend outwardly of the door or draw when the pull is secured to the door or drawer.

13. The method according to claim 11, wherein said step of providing a handle member comprises:
providing a grasping portion adapted for holding by a user;
providing a backing portion for engagement with a portion of the door or drawer and adapted for receiving the adhesive therebetween.

14. The method according to claim 13, wherein said grasping portion is at an angle to said facing portion.

15. The method according to claim 13, further comprising the step of providing an intermediate face portion between said grasping portion and said backing portion.

16. The method according to claim 15, wherein said face portion is at an angle of approximately 90° to said backing portion.

17. The method according to claim 16, wherein said grasping portion is at an angle of approximately 135° to said facing portion.

18. The method according to claim 15, wherein said grasping portion is at an angle of approximately 135° to said facing portion.

19. The method according to claim 11, wherein said handle member comprises a polycarbonate.

20. The method according to claim 11, wherein said handle member has a thickness of approximately 0.012 inch.
